(19) United States
(12) Patent Application Publication
(10) Pub. No.: US 2013/0269860 A1
(43) Pub. Date: Oct. 17, 2013

(54) TEMPERATURE-CONTROLLED DEPTH OF RELEASE LAYER

(71) Applicants: Maha M. Khayyat, Chappaqua, NY (US); Norma E. Sosa Cortes, New York, NY (US); Stephen W. Bedell, Wappingers Falls, NY (US); Keith E. Fogel, Hopewell Junction, NY (US); Devendra K. Sadana, Pleasantville, NY (US)

(72) Inventors: Maha M. Khayyat, Chappaqua, NY (US); Norma E. Sosa Cortes, New York, NY (US); Stephen W. Bedell, Wappingers Falls, NY (US); Keith E. Fogel, Hopewell Junction, NY (US); Devendra K. Sadana, Pleasantville, NY (US)

(73) Assignee: INTERNATIONAL BUSINESS MACHINES CORPORATION, Armonk, NY (US)

(21) Appl. No.: 13/448,939

(22) Filed: Apr. 17, 2012

(51) Int. Cl. B32B 38/00; B05D 3/02

(52) U.S. Cl. 156/163; 427/372.2; 427/383.1

(57) ABSTRACT

A stressor layer is formed atop a base substrate at a first temperature which induces a first tensile stress in the base substrate that is below a fracture toughness of base substrate. The base substrate and the stressor layer are then brought to a second temperature which is less than the first temperature. The second temperature induces a second tensile stress in the stressor layer which is greater than the first tensile stress and which is sufficient to allow for spalling mode fracture to occur within the base substrate. The base substrate is spalled at the second temperature to form a spalled material layer. Spalling occurs at a fracture depth which is dependent upon the fracture toughness of the base substrate, stress level within the base substrate, and the second tensile stress of the stressor layer induced at the second temperature.

### BACKGROUND

The present disclosure relates to semiconductor device manufacturing, and more particularly, to a method in which the fracture depth within a base substrate is controlled by adjusting the spalling temperature.

Devices that can be produced in thin-film form have three clear advantages over their bulk counterparts. First, by virtue of less material used, thin-film devices ameliorate the materials cost associated with device production. Second, low device weight is a definite advantage that motivates industrial-level effort for a wide range of thin-film applications. Third, if dimensions are small enough, devices can exhibit mechanical flexibility in their thin-film form. Furthermore, if a device layer is removed from a substrate that can be reused, additional fabrication cost reduction can be achieved.

Efforts to (i) create thin-film substrates from bulk materials (i.e., semiconductors) and (ii) form thin-film device layers by removing device layers from the underlying bulk substrates on which they were formed are ongoing. The controlled surface layer removal required for such applications has been successfully demonstrated using a process known as spalling; see U.S. Patent Application Publication No. 2010/0311250 to Bedell et al. Spalling includes depositing a stressor layer on a substrate, placing an optional handle substrate on the stressor layer, and inducing a crack and its propagation below the substrate/stressor interface. This process, which is performed at room temperature, removes a thin layer of the base substrate below the stressor layer. By thin, it is meant that the layer thickness is typically less than 100 microns, with a layer thickness of less than 50 microns being more typical.

### SUMMARY

The present disclosure provides a method in which a predetermined and controlled fracture depth within a base substrate can be obtained by adjusting the spalling temperature. Specifically, the method of the present disclosure is performed at a temperature which is sufficient to allow for manual or spontaneous spalling mode fracture to occur within a base substrate, not spontaneous spalling which occurs at room temperature or above as disclosed, for example, in U.S. Patent Application Publication No. 2010/0311250 to Bedell et al. The method of the present disclosure can be referred to as a spontaneous or manual spalling process in which the fracture depth is controlled by adjusting the temperature at which spalling is performed.

By “spontaneous” it is meant that the removal of a thin material layer from a base substrate occurs without the need to employ any manual means to initiate crack formation and propagation for breaking apart the thin material layer from the base substrate. By “manual” it is meant that crack formation and propagation are explicit for breaking apart the thin material layer from the base substrate. By “spalling mode fracture” it is meant that a crack is formed within the base substrate and the combination of loading forces maintains a crack trajectory at a depth below the stressor/substrate interface.

In one embodiment, the method of the present disclosure includes forming a stressor layer atop a base substrate at a first temperature. The stressor layer at the first temperature induces a first tensile stress in the base substrate that is below a fracture toughness of the base substrate. As such, spontaneous spalling does not occur at the first temperature. The base substrate and the stressor layer are then brought to a second temperature which is less than the first temperature. Specifically, and in accordance with the present disclosure, the second temperature induces a second tensile stress in the stressor layer which is greater than the first tensile stress and which is sufficient to allow for spalling mode fracture to occur within the base substrate. The base substrate is spalled at the second temperature to form a spalled material layer. In accordance with the present disclosure, spalling occurs at a fracture depth which is dependent upon the fracture toughness of the base substrate, stress level within the base substrate, and the second tensile stress of the stressor layer induced at the second temperature.

The method of the present disclosure permits one to control the thickness of the material layer being removed, i.e., spalled, from the base substrate. Specifically, the method of the present disclosure permits one to adjust the stress level within the stressor layer by tuning the spalling temperature this, in turn, controls and determines the fracture depth in the base substrate where spalling is initiated. In one embodiment, the method of the present disclosure can be employed to provide a multiplicity of spalled material layers from a multiplicity of a same type base substrate whose thickness is substantially the same or different. By “substantially the same” it is meant the thickness variation within the multiplicity of spalled material layers is within about 10% of thickness. In some embodiments, another stressor layer can be reapplied to a previously spalled base substrate and another spalling step can be performed.

Moreover, by using the aforementioned method, the effective stress that induces material spalling is modified owing to differential thermal expansion, potential crystal structure changes at the crack front, fracture toughness value differences at lower-than-room temperatures, to reach a stress regime necessary for spalling-type fracture that would not be reached using the room temperature spalling technique disclosed in U.S. Patent Application Publication No. 2010/0311250 to Bedell et al.

An advantage of the aforementioned spalling method of the present disclosure is that the layer release process can be engineered to be spontaneous during spall initiation through spall completion or be manually spalled at any desired point in time. Another advantage of the present method is that the component of stressor layer stress due to thermal expansion mismatch stress is reversible and will disappear upon warming back to room temperature, thus providing a spalled stressor layer/spalled film couple that is flatter at room temperature than at the temperature at which it was spalled. Yet another advantage of the present method is the method can widen the process window for user initiated spalling: base substrates including stressor layers having thickness/stress values lower than the threshold required for spalling at room temperature can be safely stored at room temperature until spontaneous spalling is deliberately induced by a temperature reduction.

### BRIEF DESCRIPTION OF THE DRAWINGS

FIG. 1 is a pictorial representation (through a cross sectional view) illustrating a base substrate that can be employed in one embodiment of the present disclosure.

FIG. 2 is a pictorial representation (through a cross sectional view) illustrating the base substrate of FIG. 1 after forming an optional metal-containing adhesion layer on a surface of the base substrate.

FIG. 3 is a pictorial representation (through a cross sectional view) illustrating the structure of FIG. 2 after forming a stressor layer and/or spall inducing non-metallic layer on a surface of the optional adhesion layer.

FIG. 4 is a pictorial representation (through a cross sectional view) illustrating the structure of FIG. 3 after forming an optional handle substrate atop the stressor layer.

FIG. 5 is a pictorial representation (through a cross sectional view) illustrating the structure of FIG. 4 after removing an upper portion of the base substrate.

FIG. 6 is a graph of the thickness (in μm) for spalled Si samples (right hand y axis) vs. temperature (in Kelvin, K) and of the thickness (in μm) for spalled Ge samples (left hand y axis) vs. temperature (in Kelvin, K) in accordance with an example of the present disclosure.

### DETAILED DESCRIPTION

The present disclosure, which relates to a temperature-controlled method of spalling a material layer from a base substrate, will now be described in greater detail by referring to the following discussion and drawings that accompany the present application. It is noted that the drawings of the present application are provided for illustrative purposes and, as such, they are not drawn to scale.

In the following description, numerous specific details are set forth, such as particular structures, components, materials, dimensions, processing steps and techniques, in order to provide a thorough understanding of the present invention. However, it will be appreciated by one of ordinary skill in the art that the present disclosure may be practiced with viable alternative process options without these specific details. In other instances, well-known structures or processing steps have not been described in detail in order to avoid obscuring the various embodiments of the present disclosure.

It will be understood that when an element as a layer, region, or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

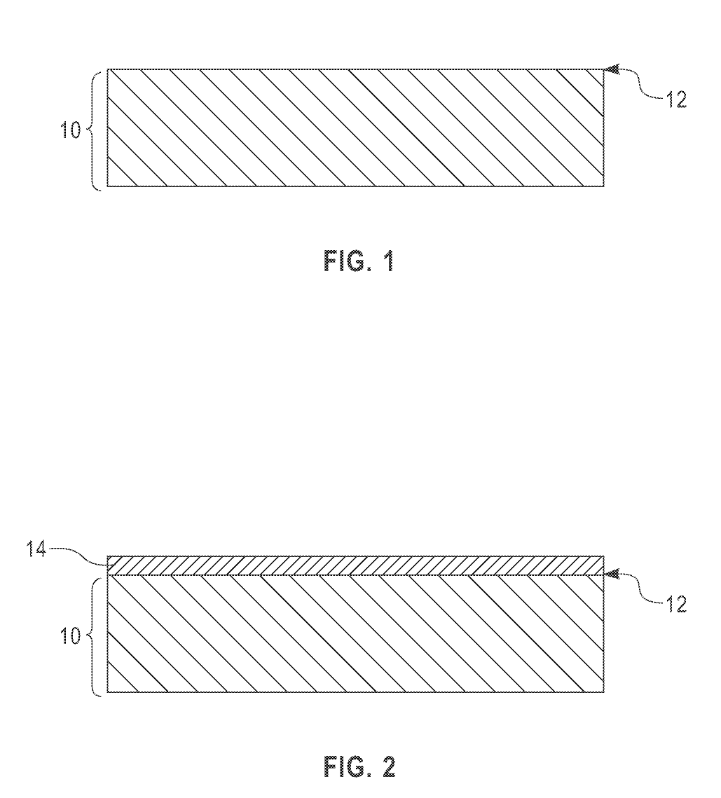

Reference is now made to FIGS. 1-5 which illustrate the basic processing steps of the method of the present disclosure which spalls, i.e., exfoliates, a material layer from a base substrate in a controlled manner. The material layer that is spalled is typically thin and may or may not include one of more devices thereon. The term “thin” is used to denote that the material layer that is spalled has a thickness that is typically less than 100 μm. Other thicknesses for the spalled material layer are possible depending on the type of stressor layer employed as well as the temperature at which spalling occurs.

Specifically, FIGS. 1-5 illustrate a method that includes forming a stressor layer atop a base substrate at a first temperature. The stressor layer at the first temperature induces a first tensile stress in the base substrate that is below a fracture toughness of the base substrate. As such, spontaneous spalling does not occur at the first temperature. The base substrate and the stressor layer are then brought to a second temperature which is less than the first temperature. Specifically, and in accordance with the present disclosure, the second temperature induces a second tensile stress in the stressor layer which is greater than the first tensile stress and which is sufficient to allow for spalling mode fracture to occur within the base substrate. The base substrate is spontaneously spalled at the second temperature to form a spalled material layer. In accordance with the present disclosure, spalling occurs at a fracture depth which is dependent upon the fracture toughness of the base substrate, stress level within the base substrate, and the second tensile stress of the stressor layer induced at the second temperature.

Referring first to FIG. 1 there is illustrated a base substrate 10 having an upper surface 12 that can be employed in the present disclosure. The base substrate 10 employed in the present disclosure may comprise a semiconductor material, a glass, a ceramic, or any another material whose fracture toughness is less than that of the stressor layer to be subsequently formed.

Fracture toughness is a property which describes the ability of a material containing a crack to resist fracture. Fracture toughness is denoted K_{Ic}. The subscript Ic denotes mode I crack opening under a normal tensile stress perpendicular to the crack, and c signifies that it is a critical value. Mode I fracture toughness is typically the most important value because spalling mode fracture usually occurs at a location in the substrate where mode II stress (shearing) is zero, and mode III stress (tearing) is generally absent from the loading conditions. Fracture toughness is a quantitative way of expressing a material's resistance to brittle fracture when a crack is present.

When the base substrate 10 comprises a semiconductor material, the semiconductor material may include, but is not limited to, Si, Ge, SiGe, SiGeC, SiC, Ge alloys, GaSb, GaP, GaAs, InAs, InP, and all other III-V or II-VI compound semiconductors. In some embodiments, the base substrate 10 is a bulk semiconductor material. In other embodiments, the base substrate 10 may comprise a layered semiconductor material such as, for example, a semiconductor-on-insulator or a semiconductor on a polymeric substrate. Illustrated examples of semiconductor-on-insulator substrates that can be employed as base substrate 10 include silicon-on-insulators and silicon-germanium-on-insulators.

When the base substrate 10 comprises a semiconductor material, the semiconductor material can be doped, undoped or contain doped regions and undoped regions.

In one embodiment, the semiconductor material that can be employed as the base substrate 10 can be single crystalline (i.e., a material in which the crystal lattice of the entire sample is continuous and unbroken to the edges of the sample, with no grain boundaries). In another embodiment, the semiconductor material that can be employed as the base substrate 10 can be a polycrystalline (i.e., a material that is composed of many crystallites of varying size and orientation; the variation in direction can be random (called random texture) or directed, possibly due to growth and processing conditions). In some embodiments, and when the semiconductor material is a polycrystalline material, the material of the present disclosure spalls certain grains, while leaving certain grains unspalled. As such, spalling of polycrystalline semiconductor material using the method of the present disclosure may produce a non-continuous spalled material layer. In yet another embodiment of the present disclosure, the semiconductor material that can be employed as the base substrate 10 can be amorphous (i.e., a non-crystalline material that lacks the long-range order characteristic of a crystal). Typically, the semiconductor material that can be employed as the base substrate 10 is a single crystalline material.

When the base substrate 10 comprises a glass, the glass can be an SiO₂-based glass which may be undoped or doped with an appropriate dopant. Examples of doped SiO₂-based glasses that can be employed as the base substrate 10 include undoped silicate glass, borosilicate glass, phosphosilicate glass, fluorosilicate glass, and borophosphosilicate glass.

When the base substrate 10 comprises a ceramic, the ceramic is any inorganic, non-metallic solid such as, for example, an oxide including, but not limited to, alumina, beryllia, ceria and zirconia, a non-oxide including, but not limited to, a carbide, a boride, a nitride or a silicide; or composites that include combinations of oxides and non-oxides.

In some embodiments of the present disclosure, one or more devices including, but not limited to, transistors, capacitors, diodes, BiCMOS, resistors, etc. can be processed on and/or within the upper surface 12 of the base substrate 10 utilizing techniques well known to those skilled in the art. The upper portion of the base substrate that includes the one or more devices can be removed utilizing the method of the present disclosure.

In some embodiments of the present disclosure, the upper surface 12 of the base substrate 10 can be cleaned prior to further processing to remove surface oxides and/or other contaminants therefrom. In one embodiment of the present disclosure, the base substrate 10 is cleaned by applying to the base substrate 10 a solvent such as, for example, acetone and isopropanol, which is capable of removing contaminates and/or surface oxides from the upper surface 12 of the base substrate 10.

In some embodiments of the present disclosure, the upper surface 12 of the base substrate 10 can be made hydrophobic by oxide removal prior to use by dipping the upper surface 12 of the base substrate 10 into hydrofluoric acid. A hydrophobic, or non-oxide, surface provides improved adhesion between said cleaned surface and certain stressor layers to be deposited.

Referring now to FIG. 2, there is illustrated the base substrate 10 of FIG. 1 after forming an optional metal-containing adhesion layer 14 on upper surface 12. The optional metal-containing adhesion layer 14 is employed in embodiments in which the stressor layer to be subsequently formed has poor adhesion to upper surface 12 of base substrate 10. Typically, the metal-containing adhesion layer 14 is employed when a stressor layer comprised of a metal is employed. In some embodiments, an optional plating seed layer (not shown) can be formed directly atop the upper surface 12 of the base substrate 10.

The optional metal-containing adhesion layer 14 employed in the present disclosure includes any metal adhesion material such as, but not limited to, Ti/W, Ti, Cr, Ni or any combination thereof. The optional metal-containing adhesion layer 14 may comprise a single layer or it may include a multilayered structure comprising at least two layers of different metal adhesion materials.

The metal-containing adhesion layer 14 that can be optionally formed on the upper surface 12 of base substrate 12 is formed at room temperature (15° C.-40° C., i.e., 288K to 313K) or above. In one embodiment, the optional metal-containing adhesion layer 14 is formed at a temperature which is from 20° C. (293K) to 180° C. (353K). In another embodiment, the optional metal-containing adhesion layer 14 is formed at a temperature which is from 20° C. (293K) to 60° C. (333K).

The metal-containing adhesion layer 14, which may be optionally employed, can be formed utilizing deposition techniques that are well known to those skilled in the art. For example, the optional metal-containing adhesion layer 14 can be formed by sputtering, chemical vapor deposition, plasma enhanced chemical vapor deposition, chemical solution deposition, physical vapor deposition, and plating. When sputter deposition is employed, the sputter deposition process may further include an in-situ sputter clean process before the deposition.

When employed, the optional metal-containing adhesion layer 14 typically has a thickness from 5 nm to 200 nm, with a thickness from 100 nm to 150 nm being more typical. Other thicknesses for the optional metal-containing adhesion layer 14 that are below and/or above the aforementioned thickness ranges can also be employed in the present disclosure.

The optional plating seed layer (not shown) is typically employed in embodiments in which the stressor layer to be subsequently formed is a metal and plating is used to form the metal-containing stressor layer. The optional plating seed layer is employed to selectively promote subsequent plating of a pre-selected metal-containing stressor layer. The optional plating seed layer may comprise, for example, single layer of Ni or a layered structure of two or more metals such as Al(bottom)/Ti/Ni(top).

The thickness of the optional plating seed layer may vary depending on the material or materials of the optional plating seed layer as well as the technique used in forming the same. Typically, the optional plating seed layer has a thickness from 2 nm to 400 nm. The optional plating seed layer can be formed by a conventional deposition process including, for example, chemical vapor deposition (CVD), plasma-enhanced chemical vapor deposition (PECVD), atomic layer deposition (ALD), and physical vapor deposition (PVD) techniques that may include evaporation and/or sputtering.

In accordance with the present disclosure, the optional metal-containing adhesion layer 14 and/or the optional plating seed layer is (are) formed at a temperature which does not effectuate spontaneous spalling to occur within the base substrate 10.

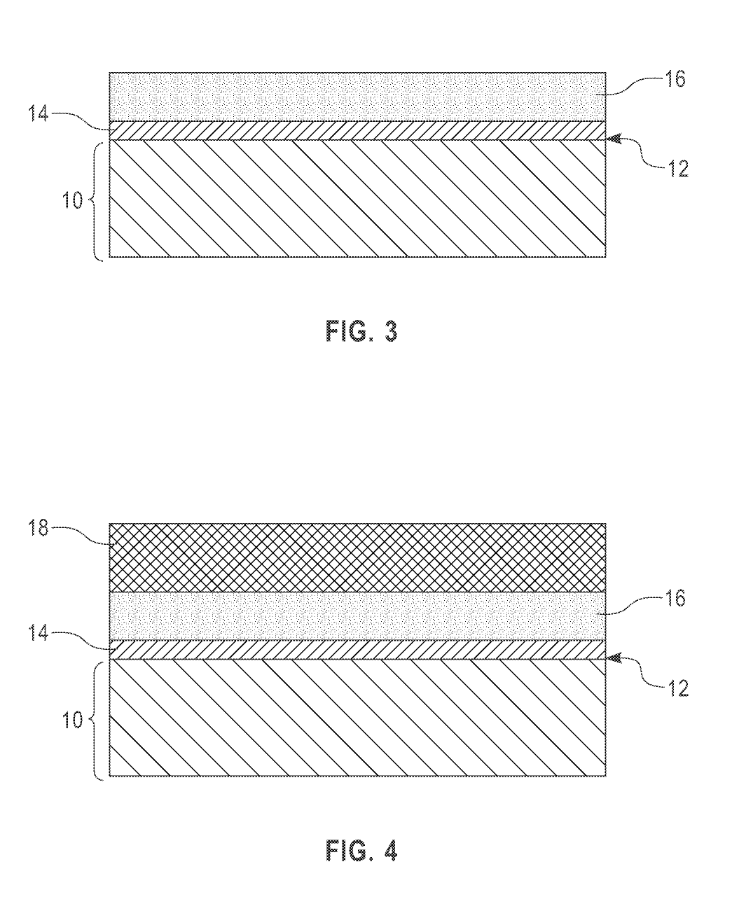

Referring now to FIG. 3, there is illustrated the structure of FIG. 2 after forming a stressor layer 16 on an upper surface of the optional metal-containing adhesion layer 14. In some embodiments in which the optional metal-containing adhesion layer 14 is not present, the stressor layer 16 is formed directly on the upper surface 12 of base substrate 10; this particular embodiment is not shown in the drawings, but can readily be deduced from the drawings illustrated in the present application. In other embodiments in which an optional plating seed layer is employed, the stressor layer 16 is formed directly on the upper surface of the optional plating seed layer; this particular embodiment is also not shown in the drawings, but can readily be deduced from the drawings illustrated in the present application.

In accordance with the present disclosure, the stressor layer 16 is formed at a first temperature which induces a first tensile stress within the base substrate 10 that is below the fracture toughness of the base substrate 10. As such, the stress layer 16 is formed at a temperature which does not initiate spalling mode fracture within the base substrate 10. In one embodiment of the present disclosure, the stressor layer 16 is formed at a first temperature that is at room temperature. By “room temperature” it is meant a temperature from 15° C. (288K) to 40° C. (313K). In another embodiment, the stressor layer 16 is formed at a first temperature that is from 15° C. (288K) to 60° C. (333K). The first tensile stress that is induced is dependent on the type of stressor material employed as well as the first temperature at which the stressor layer 16 is formed atop the base substrate 10.

The stressor layer 16 employed in the present disclosure includes any material that is under tensile stress on base substrate 10 at the first and second (i.e., spalling) temperatures. The stressor layer 16 can also be referred to a stress inducing layer.

In accordance with the present disclosure, the stressor layer 16 has a critical thickness and a stress value that cause spalling mode fracture to occur within the base substrate 10 during spalling at the second temperature. The stress value can be adjusting by tuning the second temperature at which spalling occurs. By ‘critical’, it is meant that for a given stressor material and base substrate material combination, a thickness value and a stressor value for the stressor layer is chosen that render spalling mode fracture possible (can produce a K₁ value greater than the K_{IC} of the substrate).

The thickness of the stressor layer 16 is chosen to provide the desired fracture depth within the base substrate 10. For example, if the stressor layer 16 is chosen to be Ni, then fracture will occur at a depth below the stressor layer 16 roughly 2 to 3 times the Ni thickness. The stress value for the stressor layer 16 is then chosen to satisfy the critical condition for spalling mode fracture. This can be estimated by inverting the empirical equation given by t*=[(2.5×10⁶)(K_{Ic}^{3/2})]/σ², where t* is the critical stressor layer thickness (in microns), K_{IC} is the fracture toughness (in units of MPa·m^{1/2}) of the base substrate 10 and σ is the stress value of the stressor layer (in MPa or megapascals). The above expression is a guide, in practice, spalling can occur at stress or thickness values up to 20% less than that predicted by the above expression.

Illustrative examples of such materials that are under tensile stress when applied atop the base substrate 10 at the first temperature include, but are not limited to, a metal, a polymer, such as a spall inducing tape layer, or any combination thereof. The stressor layer 16 may comprise a single stressor layer, or a multilayered stressor structure including at least two layers of different stressor material can be employed.

In one embodiment, the stressor layer 16 is a metal, and the metal is formed on an upper surface of the optional metal-containing adhesion layer 14. In another embodiment, the stressor layer 16 is a spall inducing tape, and the spall inducing tape is applied directly to the upper surface 12 of the base substrate 10. In another embodiment, for example, the stressor layer 16 may comprise a two-part stressor layer including a lower part and an upper part. The upper part of the two-part stressor layer can be comprised of a spall inducing tape layer.

When a metal is employed as the stressor layer 16, the metal can include, for example, Ni, Cr, Fe or W. Alloys of these metals can also be employed. In one embodiment, the stressor layer 16 includes at least one layer consisting of Ni.

When a polymer is employed as the stressor layer 16, the polymer is a large macromolecule composed of repeating structural units. These subunits are typically connected by covalent chemical bonds. Illustrative examples of polymers that can be employed as the stressor layer 16 include, but are not limited to, polyimides polyesters, polyolefins, polyacrylates, polyurethane, polyvinyl acetate, and polyvinyl chloride.

When a spall inducing non-metallic layer (i.e. polymeric materials such as a tape) is employed as the stressor layer 16, the spall inducing layer includes any pressure sensitive tape that is flexible, soft, and stress free at the first temperature used to form the tape, yet strong, ductile and tensile at the second temperature used during removal of the upper portion of the base substrate. By “pressure sensitive tape,” it is meant an adhesive tape that will stick with application of pressure, without the need for solvent, heat, or water for activation. Tensile stress in the tape at the second temperature is primarily due to thermal expansion mismatch between the base substrate 10 (with a lower thermal coefficient of expansion) and the tape (with a higher thermal expansion coefficient).

Typically, the pressure sensitive tape that is employed in the present disclosure as stressor layer 16 includes at least an adhesive layer and a base layer. Materials for the adhesive layer and the base layer of the pressure sensitive tape include polymeric materials such as, for example, acrylics, polyesters, olefins, and vinyls, with or without suitable plasticizers. Plasticizers are additives that can increase the plasticity of the polymeric material to which they are added.

In one embodiment, the stressor layer 16 employed in the present disclosure is formed at a first temperature which is at room temperature (15° C.-40° C., i.e., 288K-313K). In another embodiment, when a tape layer is employed, the tape layer can be formed at a first temperature which is from 15° C. (288K) to 60° C. (333K).

When the stressor layer 16 is a metal or polymer, the stressor layer 16 can be formed utilizing deposition techniques that are well known to those skilled in the art including, for example, dip coating, spin-coating, brush coating, sputtering, chemical vapor deposition, plasma enhanced chemical vapor deposition, chemical solution deposition, physical vapor deposition, and plating.

When the stressor layer 16 is a spall inducing tape layer, the tape layer can be applied by hand or by mechanical means to the structure. The spall inducing tape can be formed utilizing techniques well known in the art or they can be commercially purchased from any well known adhesive tape manufacturer. Some examples of spall inducing tapes that can be used in the present disclosure as stressor layer 16 include, for example, Nitto Denko 3193MS thermal release tape, Kapton KPT-1, and Diversified Biotech's CLEAR-170 (acrylic adhesive, vinyl base).

In one embodiment, a two-part stressor layer can be formed on a surface of a base substrate, wherein a lower part of the two-part stressor layer is formed at a first temperature which is at room temperature or slight above (e.g., from 15° C. (288K) to 60° C. (333K)), wherein an upper part of the two-part stressor layer comprises a spall inducing tape layer at an auxiliary temperature which is at room temperature. Next, the base substrate including the two-part stressor layer is brought to a second temperature which is less than room temperature. The base substrate 10 is then spalled at the second temperature to form a spalled material layer. The spalled material layer is then returned to room temperature.

If the stressor layer 16 is of a metallic nature, it typically has a thickness of from 3 μm to 50 μm, with a thickness of from 4 μm to 7 μm being more typical. Other thicknesses for the stressor layer 16 that are below and/or above the aforementioned thickness ranges can also be employed in the present disclosure.

If the stressor layer 16 is of a polymeric nature, it typically has a thickness of from 10 μm to 200 μm, with a thickness of from 50 μm to 100 μm being more typical. Other thicknesses for the stressor layer 16 that are below and/or above the aforementioned thickness ranges can also be employed in the present disclosure.

Referring to FIG. 4, there is illustrated the structure of FIG. 3 after forming an optional handle substrate 18 atop the stressor layer 16. The optional handle substrate 18 employed in the present disclosure comprises any flexible material which has a minimum radius of curvature of less than 30 cm. Illustrative examples of flexible materials that can be employed as the optional handle substrate 18 include a metal foil or a polyimide foil.

The optional handle substrate 18 can be used to provide better fracture control and more versatility in handling the spalled portion of the base substrate 10. Moreover, the optional handle substrate 18 can be used to guide the crack propagation during the spontaneous spalling process of the present disclosure.

The optional handle substrate 18 of the present disclosure is typically, but not necessarily, formed at a first temperature which is at room temperature (15° C. (288K)-40° C. (313K)).

The optional handle substrate 18 can be formed utilizing deposition techniques that are well known to those skilled in the art including, for example, dip coating, spin-coating, brush coating, sputtering, chemical vapor deposition, plasma enhanced chemical vapor deposition, chemical solution deposition, physical vapor deposition, and plating.

The optional handle substrate 18 typical has a thickness of from 1 μm to few mm, with a thickness of from 70 μm to 120 μm being more typical. Other thicknesses for the optional handle substrate 18 that are below and/or above the aforementioned thickness ranges can also be employed in the present disclosure.

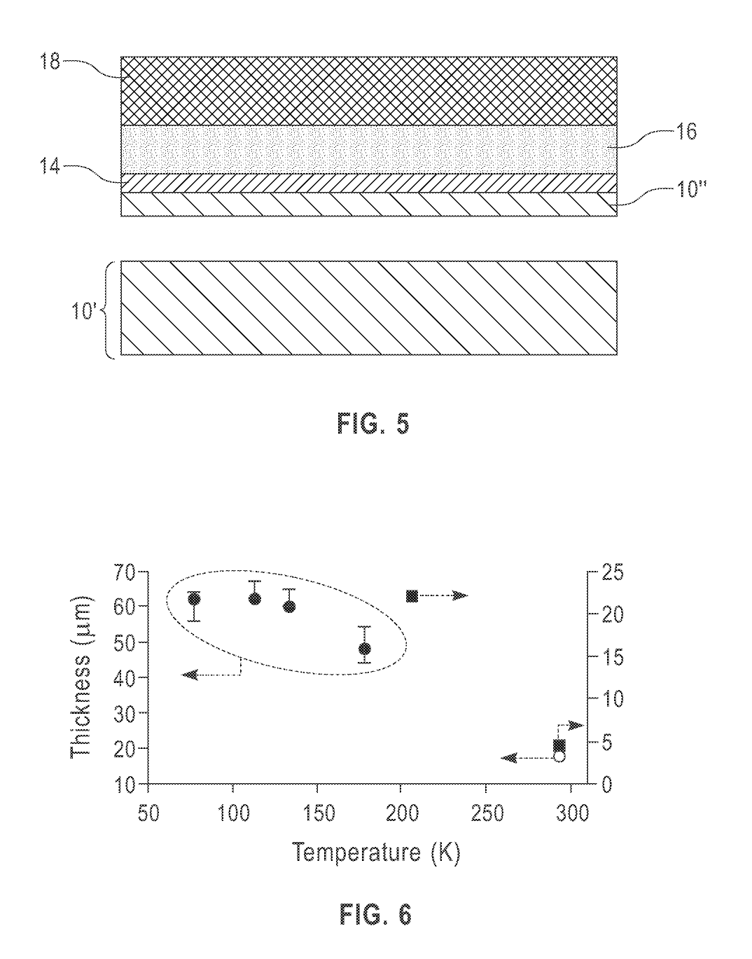

Referring to FIG. 5, there is illustrated the structure of FIG. 4 after removing an upper portion 10″ of the base substrate 10 by spontaneous spalling. In FIG. 5, reference numeral 10′ denotes the remaining base substrate 10 that is not spalled, while reference numeral 10″ denotes the spalled portion of the base substrate which can include one or more device thereon.

The spontaneous spalling process includes crack formation and propagation which are initiated at a second temperature that is less than room temperature and that is less than the first temperature used in forming the stressor layer 16. In one embodiment, the spontaneous spalling occurs at a second temperature of 77 K or less. In another embodiment, the spontaneous spalling occurs at a second temperature of less than 206 K. In yet further embodiment, the second temperature, e.g., the spontaneous spalling temperature, is from 175 K to 130 K.

Within the second temperature range mentioned above, a second tensile stress is induced in the stressor layer 16 which is greater than the first stress and which is sufficient to allow for spalling mode fracture to occur within the base substrate 10. That is, within the second temperature range, a crack begins to initiate and propagate spontaneously beneath the upper surface 12 of the base substrate 10. The fracture depth in which crack initiation begins can be adjusted in the present disclosure by tuning the second temperature at which spalling occurs. Specifically, the fracture depth at which spontaneous spalling occurs is dependent on fracture toughness of the base substrate, the effective stress level within the base substrate 10, and the second tensile stress of the stressor layer 16 that is induced at the second temperature.

The second temperature used in the present disclosure for spalling can be achieved by cooling the structure shown in FIG. 4 down below room temperature utilizing any cooling means. For example, cooling can be achieved by placing the structure in a liquid nitrogen bath, a liquid helium bath, an ice bath, a dry ice bath, a supercritical fluid bath, or any cryogenic environment liquid or gas.

In some embodiments of the present disclosure, spontaneous spalling can be initiated by lowering the first temperature to the second temperature at a fixed continuous rate. By “fixed continuous rate” it is mean, for example, 20° C. per second utilizing an electronically controlled cooling table or chamber. This method of cooling allows one to reach a pre-specified second lower temperature at which user-defined spalling initiation can induce a pre-determined spalling depth that may be different than that dictated by mere structural parameters (i.e., stressor layer stress and thickness, and fracture toughness of substrate).

In other embodiments, spontaneous spalling can be initiated by lower the first temperature at incremental steps or in a non-continuous fashion. By “incremental steps” it is meant reaching intermediate temperatures and maintaining such intermediate temperatures for a predetermined period of time. By “non-continuous fashion” it is meant that structures are subjected to cryogenic temperatures instantaneously (i.e., by submersion). This method brings the structure to a second lower temperature in the fastest amount of time and is best used for spontaneous, less-controlled spalling.

The spalled material layer 10″ that is removed from the base substrate 10 by the spontaneous spalling process mentioned above typically has a thickness of from 1000 nm to tens of μm. In some embodiments, the thickness of the spalled material layer 10″ is less than 100 μm. In other embodiments, the thickness of the spalled material layer 10′ is from 5 μm to 50 μm. The thickness of the spalled material layer 10″ correlates to the depth of crack initiation and propagation.

After the spalling process, the spalled material layer 10″ is returned to the first temperature (i.e., room temperature). This can be performed by allowing the spalled material layer 10″ to slowly heat up to the first temperature by allowing the spalled material layer 10″ to stand at room temperature. Alternatively, the spalled material layer 10″ can be heated up to room temperature utilizing any heating means.

In some embodiments of the present disclosure, the optional handle substrate 18, the stressor layer 16 and the optional metal-containing adhesion layer 14 can be removed from the spalled material layer 10″. When the optional handle substrate 18, stressor layer 16 and the optional metal-containing adhesion layer 14 are removed from the spalled material layer 10″, the removal of those layers can be achieved utilizing conventional techniques well known to those skilled in the art. For example, and in one embodiment, aqua regia (HNO₃/HCl) can be used for removing the optional handle substrate 18, the stressor layer 16 and the optional metal-containing adhesion layer 14 from the spalled material layer 10″.

The present disclosure can be used in fabricating various types of thin-film devices including, but not limited to, semiconductor devices, and photovoltaic devices.

The following example is provided to illustrate some aspects of the present disclosure and to demonstrate that by tuning the second temperature at which spalling occurs, the spalled material layer for a same type base substrate can have different thicknesses.

### EXAMPLE

In this example, the method of the present disclosure was performed on Si (100) base substrates and Ge (100) base substrate. Each base substrate that was employed had a dimension of 1.5×3 inches and the surfaces of each base substrate were dipped in HF prior to use. After dipping the surfaces of each base substrate in HF, a metal-containing adhesion layer comprised of Ti and having a thickness of about 15 nm was formed atop the surfaces of each of the base substrates. Each metal-containing adhesion layer was formed by sputtering at room temperature. Next, a stressor layer comprised of Ni and having a thickness of about 6 μm was formed atop each of the metal-containing adhesion layers by sputtering at room temperature. A flexible handle substrate was placed onto each stressor layer surface and then the structures were cooled to a second temperature which is less than room temperature using a liquid nitrogen bath.

Spalling occurred at the second temperature and the samples were removed from the liquid nitrogen bath and were heated up to room temperature in air. The thicknesses of each of the spalled material layers were then determined and were plotted in the graph shown in FIG. 6. The graph is a plot of the thickness (in μm) for spalled Si samples (right hand y axis) vs. temperature (in Kelvin, K) and of the thickness (in μm) for spalled Ge samples (left hand y axis) vs. temperature (in Kelvin, K). The circled data points represent spalled Si layers, while the square data points represent spalled Ge layers. The error bars included with the spalled Si layers denote thickness variation within the samples. As can be seen, thicker Si layers can be spalled by lowering the second temperature for the Si samples, and the Ge samples. In such cases, the lowered second temperature resulted in an increase in the second tensile stress induced by the stressor layers within the base substrate which, in turn, increased the fracture depth of the samples.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed as new is:

1. A method comprising:
forming a stressor layer atop a base substrate at a first temperature, said stressor layer at said first temperature induces a first tensile stress in said base substrate that is below a fracture toughness of said base substrate;
bringing the base substrate including said stressor layer to a second temperature which is less than said first temperature, wherein said second temperature induces a second tensile stress in said base substrate which is greater than the first tensile stress and which is sufficient to allow for spalling mode fracture to occur within said base substrate; and
spalling the base substrate at said second temperature to form a spalled material layer, wherein said spalling occurs at a fracture depth which is dependent upon the fracture toughness of the base substrate, stress level within the base substrate, and the second tensile stress of said stressor layer induced at said second temperature.

2. The method of claim 1, wherein said fracture toughness of said base substrate is lower than a fracture toughness of said stressor layer.

3. The method of claim 2, wherein said base substrate comprises a semiconductor material, a glass, or a ceramic.

4. The method of claim 3, wherein said base substrate is a semiconductor substrate, and said semiconductor substrate is single crystalline.

5. The method of claim 1, further comprising forming a metal-containing adhesive layer between said stressor layer and said base substrate.

6. The method of claim 1, wherein said stressor layer is a metal, a polymer, a spall inducing tape layer or any combination thereof.

7. The method of claim 1, wherein said stressor layer is a metal, and said metal comprises Ni, Cr, Fe or W.

8. The method of claim 1, wherein said stressor layer is a spall inducing tape layer, and said spall inducing tape layer is a pressure sensitive tape that is flexible and stress free at said first temperature, yet ductile and under tensile stress at the second temperature.

9. The method of claim 8, wherein said pressure sensitive tape comprises at least an adhesive layer and a base layer.

10. The method of claim 1, wherein the stressor layer comprises a two-part stressor layer including a lower part and an upper part, said upper part comprising a spall inducing tape layer.

11. The method of claim 1, further comprising forming a handle substrate atop said stressor layer and at said first temperature.

12. The method of claim 1, wherein said first temperature is room temperature and said second temperature is 77K or less.

13. The method of claim 1, wherein said first temperature is room temperature and said second temperature is less than 206K.

14. The method of claim 1, wherein said stressor layer is a pressure sensitive tape, said first temperature is from 288K to 333K and said second temperature is 77K or less.

15. The method of claim 1, wherein said stressor layer is a pressure sensitive tape, said first temperature is from 288K to 333K and said second temperature is less than 206K.

16. The method of claim 1, wherein said stressor layer consists of a metal and wherein a metal-containing adhesive layer is located between said stressor layer and said base substrate.

17. The method of claim 1, wherein said first temperature is lowered at a fixed continuous rate to said second temperature.

18. The method of claim 1, wherein said first temperature is lowered to said second temperature at incremental steps or in a non-continuous fashion.

19. The method of claim 1, wherein said spalled material layer has a thickness of less than 100 μm.

20. The method of claim 1, wherein said first stress is below conditions in which spontaneous spalling occurs, while said second temperature is near or above conditions in which spontaneous spalling occurs.
